(19) United States
(12) Patent Application Publication
(10) Pub. No.: US 2002/0158991 A1
(43) Pub. Date: Oct. 31, 2002

(54) Wireless moving image and audio transmitting system

(76) Inventors: Hisakazu Kobayashi, Hyogo (JP); Norihiko Kumon, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/842,668

(22) Filed: Apr. 27, 2001

(51) Int. Cl. H04N 11/02

(52) U.S. Cl. 348/723; 348/423.1

(57) ABSTRACT

A wireless moving image and audio transmitting system capable of enhancing the display quality of moving image and output quality of audio without expanding the bandwidth of radio communication is disclosed. The wireless moving image and audio transmitting system comprises a moving image and audio transmitter and a portable display terminal. When the portable display terminal is near the moving image and audio transmitter, the sound input from the audio input unit of the moving image and audio transmitter is directly output from the speaker of the audio output unit. At this time, the moving image and audio transmitter transmits the input moving image at a low compression rate to the portable display terminal. Thus, the display quality of moving image and output quality of audio can be enhanced without expanding the bandwidth of radio communication.

### FIELD OF THE INVENTION

The present invention relates to a wireless moving image and audio transmitting system capable of transmitting audio by selecting an audio output appropriate for application.

### BACKGROUND OF THE INVENTION

Recently, as the radio communication technology and compression coding technology are advanced, the information processing apparatus and system are widely spreading for making radio communications between personal computers, between a personal computer and peripheral device, or between other information terminals and controlling information transmission and devices. Therein, the apparatuses are becoming smaller and lighter, and more portable. Accordingly, of the two radio communication apparatuses, one is often portable and other is stationary. In this trend, the system for wireless transmission of moving image data and audio data and reception in the portable display terminal has been put in practical use.

A conventional example is explained convention.

A wireless moving image and audio transmitting system contains a moving image and audio transmitter (hereinafter transmitter) 1 and a portable display terminal (portable terminal) 2. The transmitter 1 and portable terminal 2 may communicate with each other through, for example, a mobile communication network.

FIG. 7 is a configuration of the transmitter in the conventional wireless moving image and audio transmitting system.

In FIG. 7, a moving image input unit 11 of the transmitter 1 feeds a moving image. A moving image compression coder 12 compression-codes the moving image data output from the moving image input unit 11 into data applicable to radio transmission. An audio input unit 13 feeds audio data. An audio compression coder 14 compression-codes the audio data output from the audio input unit 13 into data applicable to radio transmission. A radio transmitting unit 15 multiplexes the moving image data and audio data thus compression-coded, and transmits the data to the portable terminal 2 by radio communication.

The moving image input unit is a video camera or recording and reproducing apparatus, and produces moving image data or still image data. It can be installed either inside or outside of the casing of the transmitter 1.

The audio input unit is a microphone or audio reproducing apparatus, and produces audio data. It can be also installed either inside or outside of the casing of the transmitter.

FIG. 8 illustrates a configuration of the portable terminal in the wireless moving image and audio transmitting system.

In the portable terminal 2 in FIG. 8, a radio receiving unit 26 receives compression-coded moving image data and audio data from the transmitter 1, and demultiplexes them. A moving image decoder 27 decodes the demultiplexed compresssion-coded moving image data. A moving image display unit 28 displays the moving image data decoded by the moving image decoder 27. An audio decoder 29 decodes the compression-coded audio data demultiplexed in the radio receiving unit 26. An audio output unit 30 outputs the audio data decoded by the audio decoder 29 through the speaker.

In the conventional wireless moving image and audio transmitting system, the transmitter 1 transmits moving image and audio. The portable terminal 2 receives the moving image and audio. At this time, the display unit 28 displays the moving image. The audio output unit 30 outputs the audio through the speaker.

In the conventional wireless moving image and audio transmitting system, a large speaker could not be used so as not to sacrifice the portability of the portable display terminal. As a result, the tone quality was poor.

Besides, the bandwidth of radio communication was limited, and the bandwidth could not be widened, and hence it was difficult to transmit the moving image of high picture quality and sound of high tone quality.

### SUMMARY OF THE INVENTION

It is hence an object of the wireless moving image and audio transmitting system of the invention to enhance the picture quality and tone quality, depending on the distance between the display terminal and transmitter, by using the limited bandwidth of radio communication, without sacrificing the portability of portable display terminal.

More specifically, when the portable display terminal is installed near the moving image and audio transmitter, that is, when the transmitter and portable display terminal are installed, for example, in the same household, the portability of the portable display terminal is not spoiled, and the bandwidth of radio communication is not widened. At the same time, the picture quality of the moving image and tone quality of the sound seen and heard by the user are enhanced.

The wireless moving image and audio transmitting system of the invention contains a moving image and audio transmitter, and a portable display terminal for communicating with the moving image and audio transmitter and receiving at least one of moving image and audio signal.

In the moving image and audio transmitter:

A moving image compression coder compression-codes a moving image output from the moving image input unit.

An audio compression coder compression-codes an audio signal.

A radio transmitting unit transmits the moving image compressed and coded in the moving image compression coder and audio compression-coded in the audio compressing coder. An audio output unit outputs an audio signal.

An audio output instructing unit determines whether to transmit the audio signal by the radio transmitting unit or audio output unit, depending on the distance between the moving image and audio transmitter and the portable display terminal.

In the portable display terminal:

A radio receiving unit receives the compression-coded moving image and compressed and coded audio signal.

A moving image decoder decodes the moving image received in the radio receiving unit.

A display unit displays the moving image decoded by the moving image decoder.

An audio decoder decodes the audio signal received in the radio receiving unit.

An audio output unit outputs the audio signal decoded by the audio decoder.

An audio output determining unit determines whether to output the audio through the audio output unit or not, depending on the distance between the moving image and audio transmitter and the portable display terminal.

In this system, when the portable display terminal is installed closely to the moving image and audio transmitter, for example, on the same desk in the household, the sound is output from the audio output unit incorporated in the casing of the transmitter, or the audio output unit connected by wire outside the casing of the transmitter. It hence prevents lowering of audio output or tone quality due to limit in the size of the speaker in relation to tone quality deterioration or portability by compression-coding of audio data.

Further, when the portable display terminal is installed closely to the transmitter, the audio output destination is changed by the instruction from the audio output instructing unit, and at the same time the compression rate of the moving image in the moving image compressing coder is controlled. Thus, without widening the bandwidth, the picture quality of moving image can be enhanced.

### BRIEF DESCRIPTION OF THE DRAWINGS

FIG. 1 illustrates a configuration of moving image and audio transmitter in embodiment 1 of the invention.

FIG. 2 illustrates a configuration of moving image and audio transmitter in embodiment 2 of the invention.

FIG. 3 illustrates a configuration of moving image and audio transmitter in embodiment 3 of the invention.

FIG. 4 illustrates a configuration of portable display terminal in embodiment 4 of the invention.

FIG. 5(a) is a perspective outline view of moving image and audio transmitter.

FIG. 5(b) is a perspective outline view showing the state of portable display terminal installed on a casing of the moving image and audio transmitter.

FIG. 6 is a perspective outline view of portable display terminal in embodiment 6 of the invention.

FIG. 7 is a configuration of a conventional moving image and audio transmitter.

FIG. 8 is a configuration of a conventional portable display terminal.

### DESCRIPTION OF THE PREFERRED EMBODIMENTS

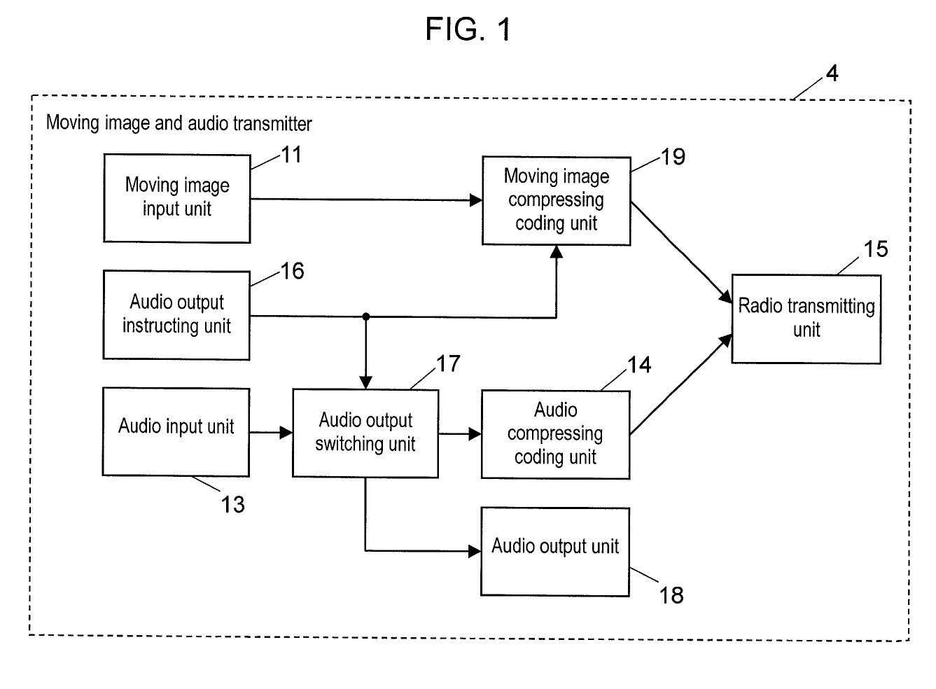

Preferred embodiments of the invention are described below by referring to FIG. 1 to FIG. 6.

(Embodiment 1)

Embodiment 1 is explained by referring to FIG. 1.

FIG. 1 is a configuration of moving image and audio transmitter (hereinafter transmitter) in embodiment 1 of the invention.

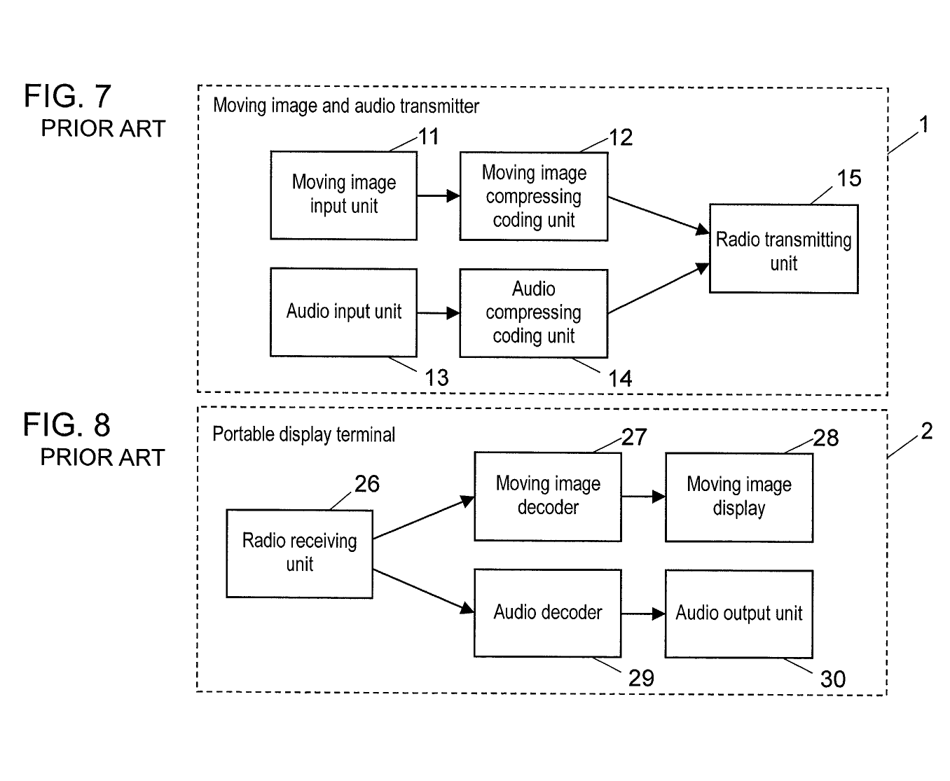

The same parts as in FIG. 7 and FIG. 8 are identified with the same reference numerals and explanation is omitted.

In FIG. 1, a moving image input unit 11, an audio input unit 13, and an audio compressing coder 14 are the same as those in the transmitter 1 in FIG. 7, and explanation is omitted.

In the transmitter 4 of embodiment 1 of the invention in FIG. 1, a moving image is output in the moving image input unit 11. A moving image compression coder 19 controls the compression rate of the moving image data input from the moving image input unit 11 by an external control signal. Audio data is input in the audio input unit 13. A radio transmitting unit 15 multiplexes the moving image compression-coded in the moving image compression coder 19 and audio data compression-coded in the audio compressing coder 14 and transmits them by radio communication.

An audio output instructing unit 16 instructs the output destination of the audio data output from the audio input unit 13 and change of compression rate of the moving image compression coder 19. An audio output switching unit 17 selects the output destination of the audio data instructed by the audio output instructing unit 16. An audio output unit 18 is connected to the audio output switching unit 17 by wiring, and the sound input by the audio input unit 13 is output from the speaker.

The operation of the wireless moving image and audio transmitting system in embodiment 1 is explained below.

When the user uses the portable display terminal (hereinafter portable terminal) 7 in a place remote from the transmitter 4, the audio output instructing unit 16 instructs the audio output switching unit 17 to output the audio data to the audio compression coder 14.

The audio data is compression-coded in the audio compression coder 14, and is transmitted to the portable terminal through the radio transmitting unit 15 and mobile communication network, and is reproduced as sound in the portable terminal 5.

On the other hand, when the user uses the portable terminal 7 in a place close to the transmitter 4, the audio output instructing unit 16 instructs the audio output switching unit 17 to output the audio data to the audio output unit 18. The audio output switching unit 17 outputs the audio data to the audio output unit 18.

That is, the sound is output from the speaker built in the casing of the transmitter 4 or a speaker connected and installed outside of the casing by wiring.

The audio output instructing unit 16 instructs to output the sound from the audio output unit 18, and at the same time instructs the moving image compressing coder 19 to lower the compression rate of the moving image data.

The moving image compressing coder 12 lowers the compression rate of the moving image data, and transmits only the moving image data in the same band as in the case of output of audio data to the portable terminal 7. Accordingly, the bandwidth for transmitting the moving image is wider, and the picture quality of the moving image displayed in the portable terminal is enhanced.

In the wireless moving image and audio transmitting system of embodiment 1, when the transmitter 4 and portable terminal are used in a close distance, the audio data input from the input unit 13 is directly output as sound from the audio output unit 18 of the transmitter 4. Therefore, it is free from deterioration by compression coding of the audio data or limitation of speaker size in the portable terminal, so that the output quality of audio data may be enhanced.

Further, since no sound is doutput from the portable terminal 7, the compression rate of moving image data can be lowered, and therefore the picture quality of the moving image displayed in the portable terminal 2 can be also enhanced.

(Embodiment 2)

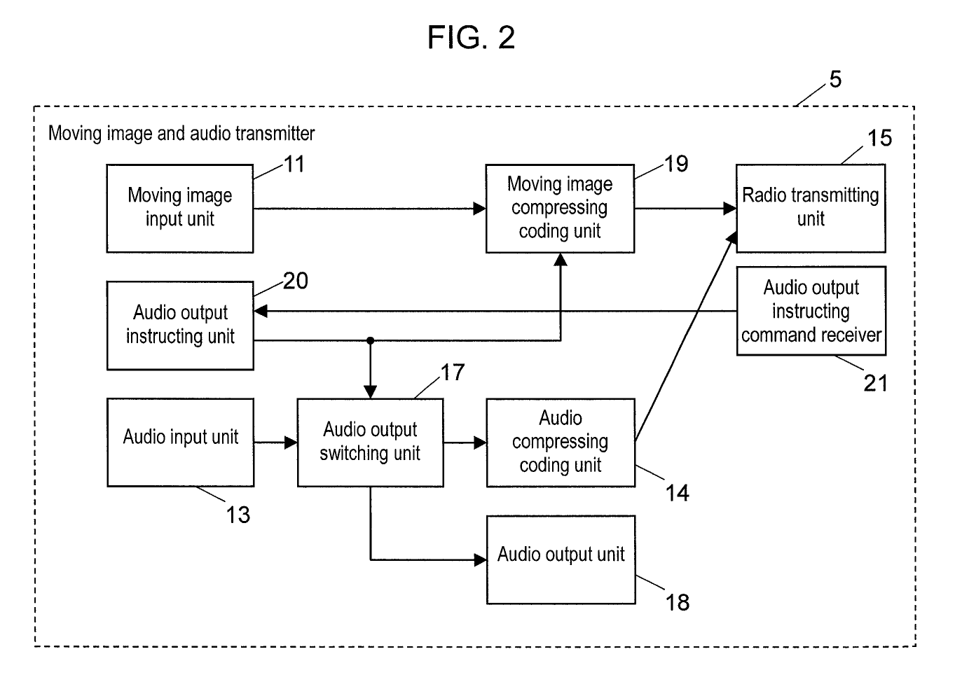

Embodiment 2 is explained by referring to FIG. 2.

FIG. 2 illustrates a configuration of moving image and audio transmitter in embodiment 2.

The same parts as in the prior art and embodiment 1 are identified with the same reference numerals, and the explanation is omitted.

In the transmitter 5 of embodiment 2, in addition to the transmitter 4 of embodiment 1, an audio output instructing command receiver (hereinafter command receiver) 21 is provided for receiving an audio output instructing command (hereinafter command) transmitted from the portable terminal 7.

An audio output instructing unit 20, receiving this command, notices the audio output destination to the audio output switching unit 17. In this embodiment, this function is added to the audio output instructing unit 16 of the transmitter 4 in embodiment 1.

The command receiver 21 receives the command from the portable terminal 7, and notices this command to the audio output instructing unit 20.

Responsive to the noticed command, the audio output instructing unit 20 instructs the audio output destination to the audio output switching unit 17.

Also responsive to the command, the audio output instructing unit 20 instructs the moving image compressing coder 19 to lower the compression rate of the moving image.

According to the wireless moving image and audio transmitting system of embodiment 2, the user, when placing the portable terminal near the transmitter 5, changes over the audio output destination from the portable terminal 7. At this time, the user can hear the sound of high quality from the transmitter 5. The user also instructs to lower the compression rate of the moving image from the portable terminal 7, so that the moving image of high picture quality can be seen in the portable terminal 7.

(Embodiment 3)

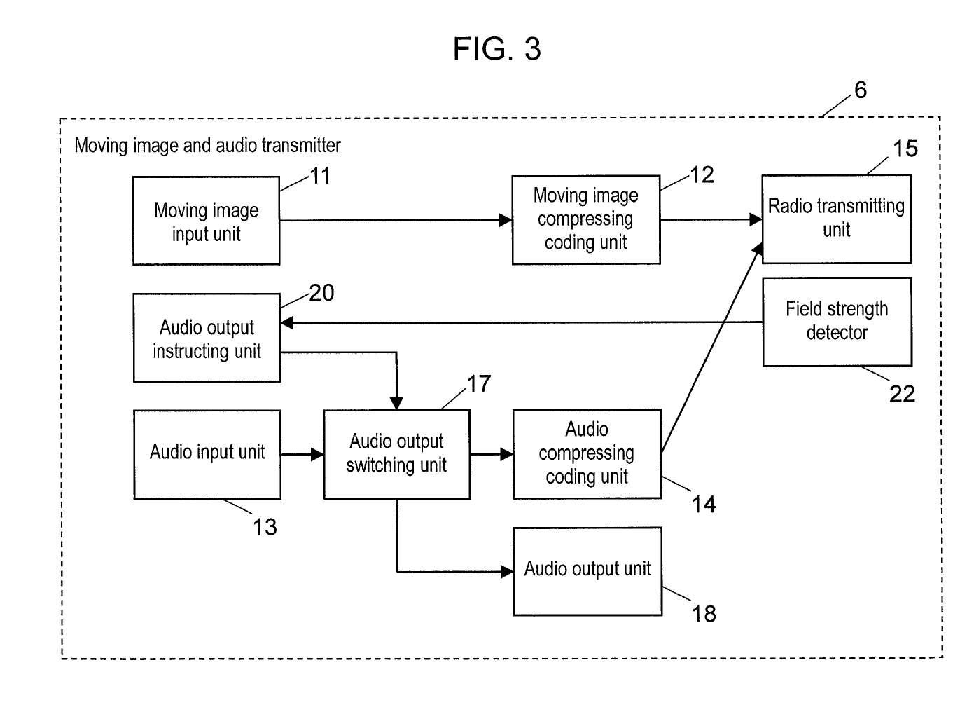

Embodiment 3 is explained by referring to FIG. 3.

FIG. 3 illustrates a configuration of moving image and audio transmitter in embodiment 3.

The same parts as in the prior art and embodiments 1 and 2 are identified with same reference numerals, and explanation is omitted.

In the transmitter 6 of embodiment 3, in addition to the transmitter 4 of embodiment 1, a field strength detector 22 is provided in order to measure the field strength of the field strength measuring wave transmitted from the portable terminal 7. The audio output instructing unit 20 notices the audio output destination to the audio output switching unit 17 depending on the magnitude of the field strength. In this embodiment, this function is added to the audio output instructing unit 16 of the transmitter 4 of embodiment 1.

The field strength detector 22 measures the field strength of the radio wave transmitted from the portable terminal, and calculates the distance between the transmitter 6 and portable terminal 7. Depending on the result, the detector 22 notices whether the distance is shorter than a predetermined value, to the audio output instructing unit 20.

When receiving the notice that the distance is shorter than predetermined value, the audio output instructing unit 20 judges that the distance between the transmitter 6 and portable terminal 7 is short. At this time, the instructing unit 20 instructs the audio output switching unit 17 to output the sound from the audio output unit 18 of the transmitter 6.

If longer than predetermined value, the audio output instructing unit 20 judges that the distance is far, and instructs the audio output switching unit 17 to transmit the audio data to the portable terminal 7.

According to the wireless moving image and audio transmitting system of embodiment 3, the transmitter 6 calculates the distance to the portable terminal 7, and outputs the sound to the optimum output destination by automatically changing over.

(Embodiment 4)

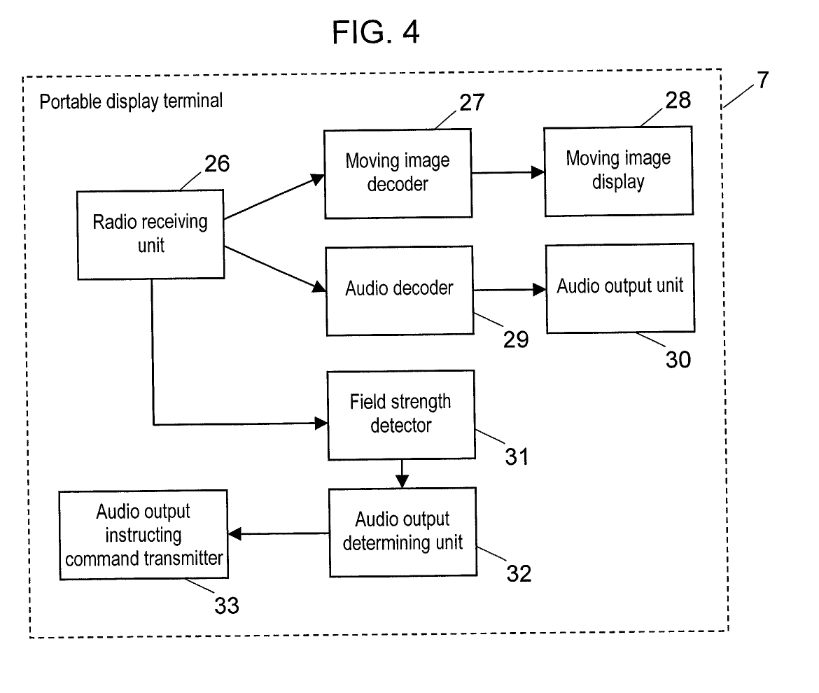

Embodiment 4 is explained by referring to FIG. 4.

FIG. 4 illustrates a configuration of portable display terminal in embodiment 4.

The same parts as in FIG. 8 are identified with the same reference numerals, and explanation is omitted.

In FIG. 4, a radio receiving unit 26, a moving image decoder 27, a moving image display 28, an audio decoder 29, and an audio output unit 30 works as the same way as those in the portable display terminal 2 in FIG. 8, and the explanation is omitted.

In the following explanation, the transmitter 5 in embodiment 2 is used as the moving image and audio transmitter.

In embodiment 4 of the invention, the portable display terminal 7 (hereinafter portable terminal 7) comprises the radio receiving unit 26, moving image decoder 27, moving image display 28, audio decoder 29, and audio output unit 30.

Further, a field strength detector 31 measures the field strength of the radio wave transmitted from the transmitter 5 in embodiment 2. An audio output determining unit 32 determines the audio output destination depending on the output from the field strength detector 31. An audio output instructing command transmitter 33 transmits the audio output instructing command (hereinafter command) to the transmitter 5 according to the instruction from the audio output determining unit 32.

The field strength detector 31 measures the field strength of the radio wave transmitted from the transmitter 5, and calculates the distance between the portable terminal 7 and transmitter 5. The detector 31 notices the result to the audio output determining unit 32.

The audio output determining unit 32, when the distance between the portable terminal 7 and transmitter 5 is judged to be short, determines to output the sound from the audio output unit 18 of the transmitter 5.

If judged to be distant, it is determined to output the sound from the audio output unit 30 of the portable terminal 7.

The audio output instructing command transmitter 33 creates an audio output instructing command according to the determination in the audio output determining unit 32, and transmits to the transmitter 5.

In the transmitter 5 of embodiment 2, the command receiver 21 receives the command from the portable terminal 7, and notices this command to the audio output instructing unit 16.

The audio output instructing unit 20 instructs the audio output destination to the audio output switching unit 17 according to the noticed command.

Also responsive to the command, the audio output instructing unit 20 instructs the moving image compressing coder 19 to lower the compression rate of the moving image.

According to the wireless moving image and audio transmitting system of embodiment 4, when the user places the portable terminal 7 near the transmitter 5, the transmitter 5 automatically changes over the audio output destination by receiving the command sent from the portable terminal 7. At this time, the user can hear the sound of high tone quality from the transmitter 5. The transmitter 5 also instructs to lower the compression rate of the moving image, so that the moving image of high picture quality can be seen in the portable terminal 7.

Moreover, the portable terminal 7 can calculate the distance to the transmitter, without separately transmitting radio wave of large power consumption for the purpose of measuring the field strength, so that the sound can be output by automatically changing over to the optimum output destination.

(Embodiment 5)

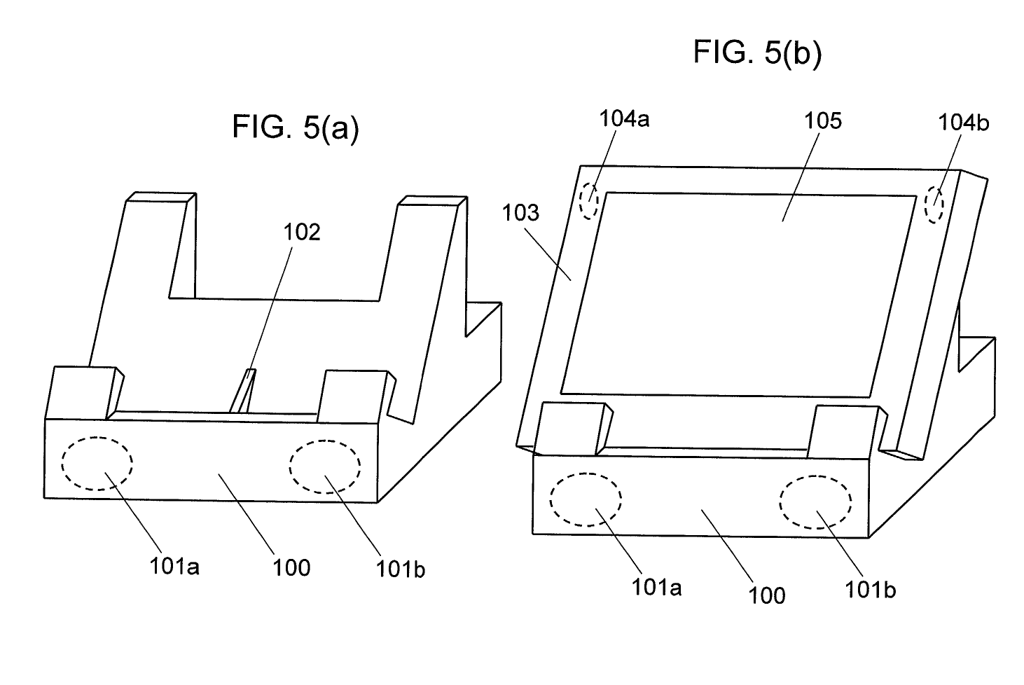

Embodiment 5 is explained by referring to FIG. 5.

FIG. 5(a) is a perspective outline view of moving image and audio transmitter.

FIG. 5(b) is a perspective outline view showing the state of portable display terminal installed on a casing of the moving image and audio transmitter.

In FIG. 5, a moving image and audio transmitter 100 includes two built-in speakers 101a, 101b, and a detection switch 102 for detecting when a portable display terminal is placed. A portable display terminal 103 comprises two built-in speakers 104a, 104b, and a liquid crystal display panel 105.

The detection switch 102 of the moving image and audio transmitter 100 is connected to the audio output instructing unit 16 in FIG. 1.

When the portable display terminal 103 is put on the transmitter 100, the detection switch 102 is turned on, and the audio output instructing unit 16 instructs to output sound from the speakers of the transmitter 100.

When the portable display terminal 103 is not put on the transmitter 100, it is turned off, and the audio output instructing unit 16 instructs to output sound from the speakers of the portable display terminal 103.

In the wireless moving image and audio transmitting system of embodiment 5, when the portable display terminal 103 is remote from the moving image and audio transmitter 100, the sound is output from the speakers 104a, 104b positioned in front of the user viewing the liquid crystal display panel 105 of the portable display terminal 103. When the display terminal 103 is put on the casing of the transmitter 100, the sound of high tone quality is output from the speakers 101a, 101b of the moving image and audio transmitter 100.

(Embodiment 6)

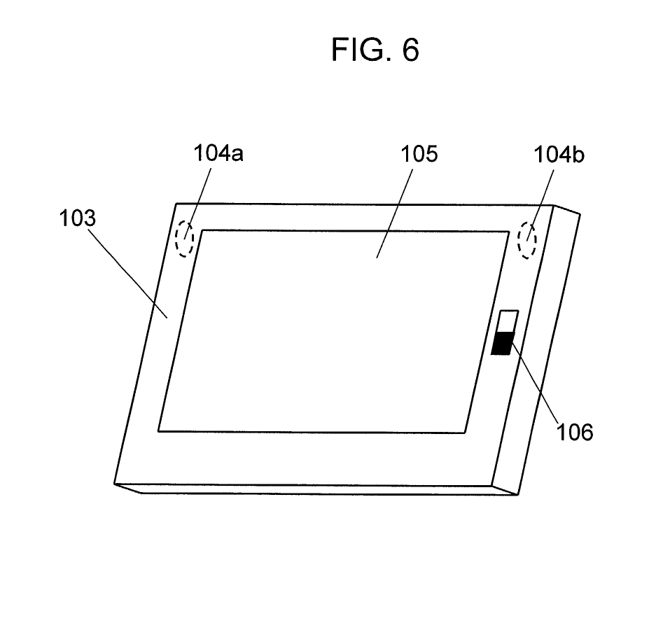

Embodiment 6 is explained by referring to FIG. 6.

FIG. 6 is a perspective outline view of portable display terminal in embodiment 6.

In the wireless moving image and audio transmitting system of this embodiment, the moving image and audio transmitter 100, and built-in speakers 104a, 104b and liquid crystal display panel 105 of the portable display terminal 103 are the same as in embodiment 5, and explanation is omitted.

What differs from embodiment 5 is that a changeover switch 106 for selecting the audio output destination is provided closely to the liquid crystal display panel 105 of the portable display terminal 103.

In FIG. 6, the user changes over the changeover switch 106 of the portable display terminal 103 regardless of the distance between the moving image and audio transmitter 100 and portable display terminal 103. At this time, the portable display terminal 103 transmits the audio output instructing command instructing the audio output destination to the moving image and audio transmitter 100 by radio communication.

In embodiment 6, the changeover switch 106 is shown as a physical switch, but the same effect is obtained by using a software switch to be changed by operation of icon or the like.

As described herein, according to the moving image and audio transmitting system of the invention, when the portable display terminal is placed near the moving image and audio transmitter, in the moving image and audio transmitter, the sound input from the audio input unit is output directly from the speaker of the audio output unit. At the same time, the moving image data input from the moving image input unit is transmitted to the portable display terminal at low compression rate by radio communication. As a result, the display quality of the moving image and output quality of audio can be enhanced without expanding the bandwidth of radio communication.

As explained in the embodiments, meanwhile, when the portable terminal is placed near the transmitter, short distance radio data communication may be employed as the radio transmitting means from the portable terminal, or radio transmitting means of image data or audio data from the transmitter. The short distance radio data communication is a kind of mutual wireless connection between the transmitter and the portable terminal without a mobile communication network, including, for example, communication by using Bluetooth.

The moving image and audio transmitter can also transmit moving image data or audio data to the portable display terminal through mobile communication network.

What is claimed is:

1. A moving image and audio transmitter for transmitting at least one of moving image and an audio signal to a communication terminal, comprising:
a) a moving image compression coder for compression coding the moving image signal output from a moving image input unit,
b) an audio compression coder for compressing and coding the audio signal,
e) a radio transmitting unit for transmitting the moving image data compressed and coded in the moving image compression coder, and the audio data compression-coded in the audio compression coder,
f) an audio output unit for outputting the audio signal, and
g) an audio output instructing unit for determining a selection on whether to transmit the audio signal by said radio transmitting unit or to output in said audio output unit, depending on a distance between the moving image and audio transmitter and said communication terminal.

2. The moving image and audio transmitter of claim 1,
wherein said audio output instructing unit controls a compression rate of said moving image compression coder depending on the selection.

3. The moving image and audio transmitter of claim 1,
wherein said audio output instructing unit detects contact of said moving image and audio transmitter with said communication terminal, and i) instructs a selection of audio, and ii) controls a compression rate of said moving image compressing coder.

4. The moving image and audio transmitter of claim 2,
wherein said audio output instructing unit detects contact of said moving image and audio transmitter with said communication terminal, and i) instructs a selection of audio, and ii) controls the compression rate of said moving image compression coder.

5. The moving image and audio transmitter of claim 1, further comprising:
an audio output instructing command receiver for receiving an audio output instructing command from said communication terminal,
wherein said audio output instructing unit instructs the selection according to the audio output instructing command received in said audio output instructing command receiver.

6. The moving image and audio transmitter of claim 2, further comprising:
an audio output instructing command receiver for receiving an audio output instructing command from said communication terminal,
wherein said audio output instructing unit instructs the selection according to the audio output instructing command received in said audio output instructing command receiver.

7. The moving image and audio transmitter of claim 1, further comprising:
a field strength detector for measuring a field strength of radio wave transmitted from the communication terminal,
wherein said audio output instructing unit instructs the selection according to a measuring result of said field strength detector.

8. The moving image and audio transmitter of claim 2, further comprising:
a field strength detector for measuring a field strength of radio wave transmitted from said communication terminal,
wherein said audio output instructing unit instructs the selection according to the measuring result of said field strength detector.

9. A portable display terminal for communicating with a communication terminal, and receiving at least one of moving image data and audio data, comprising:
a) a radio receiving unit for receiving compression-coded moving image data and compression-coded audio data,
b) a moving image decoder for decoding the moving image data received in said radio receiving unit,
c) a display unit for displaying the image according to the moving image data decoded by said moving image decoder,
d) an audio decoder for decoding the audio data received in said radio receiving unit,
e) an audio output unit for issuing the audio signal decoded by said audio decoder, and
f) an audio output determining unit for determining whether or not to output the audio signal from the audio output unit, depending on a distance between said moving image and audio transmitter and communication terminal.

10. The portable display terminal of claim 9,
wherein said audio output determining unit includes an audio output instructing command transmitter for transmitting the output instructing command to designate an output destination of the audio signal at the communication terminal, to the communication terminal.

11. The portable display terminal of claim 10,
wherein said audio output determining unit is a changeover switch.

12. The portable display terminal of claim 10, further comprising:
a field strength detector for measuring a field strength of radio wave transmitted from said communication terminal,
wherein said audio output determining unit determines the output destination of the audio signal at said communication terminal according to the measured field strength.

13. A wireless moving image and audio transmitting system for communicating information including at least one of moving image data and audio data, comprising:
1) a moving image and audio transmitter, and
2) a portable display terminal for communicating with said moving image and audio transmitter and receiving at least one of the moving image data and the audio data,
wherein said moving image and audio transmitter comprises:
a) a moving image compressing coder for compressing and coding a moving image signal ouput from a moving image input unit,
b) an audio compressing coder for compressing and coding an audio signal,
c) a radio transmitting unit for transmitting the moving image data compressed and coded in the moving image compressing coder, and the audio data compressed and coded in the audio compressing coder,
d) an audio output unit for issuing the audio, and
e) an audio output instructing unit for determining a selection on whether to transmit the audio by the radio transmitting unit or to output in the audio output unit, depending on a distance between the moving image and audio transmitter and the portable display terminal, and
said portable display terminal comprises:
a′) a radio receiving unit for receiving compression-coded moving image data and compression-coded audio data,
b′) a moving image decoder for decoding the moving image data received in said radio receiving unit,
c′) a display unit for displaying the image according to the moving image data decoded by said moving image decoder,
d′) an audio decoder for decoding the audio data received in said radio receiving unit,
e′) an audio output unit for issuing the audio signal decoded by said audio decoder, and
f′) an audio output determining unit for determining whether or not to output the audio signal from the audio output unit, depending on the distance between said moving image and audio transmitter and the portable display terminal.

14. The wireless moving image and audio transmitting system of claim 13,
wherein said audio output instructing unit controls a compression rate of the moving image compressing coder depending on the selection.

15. The wireless moving image and audio transmitting system of claim 13,
wherein said audio output instructing unit detects contact of the moving image and audio transmitter with the portable display terminal, and i) instructs selection of audio, and ii) controls a compression rate of the moving image compressing coder.

16. The wireless moving image and audio transmitting system of claim 13,
wherein said moving image and audio transmitter further comprises:
an audio output instructing command receiver for receiving an audio output instructing command from the portable display terminal, and
said audio output instructing unit instructs the selection according to the audio output instructing command received in said audio output instructing command receiver.

17. The wireless moving image and audio transmitting system of claim 13,
wherein said moving image and audio transmitter further comprises:
a field strength detector for measuring the field strength of radio wave transmitted from the portable display terminal, and
said audio output instructing unit instructs the selection according to the measuring result of said field strength detector.

18. The wireless moving image and audio transmitting system of claim 13,
wherein said audio output determining unit of said portable display terminal further comprises:
an audio output instructing command transmitter for transmitting the output instructing command to designate an output destination of the audio at the communication terminal, to the moving image transmitter.

19. The wireless moving image and audio transmitting system of claim 18,
wherein said audio output determining unit is a changeover switch.

20. The wireless moving image and audio transmitting system of claim 18,
wherein said portable display terminal further comprises:
a field strength detector for measuring a field strength of radio wave transmitted from the moving image transmitter,
wherein said audio output determining unit determines the output destination of the audio at the communication terminal according to the measured field strength.
